(19) United States
(12) Patent Application Publication
(10) Pub. No.: US 2025/0264611 A1
(43) Pub. Date: Aug. 21, 2025

(54) Laser Sensor System With Pattern Scanning

(71) Applicant: The Boeing Company, Arlington, VA (US)

(72) Inventors: Nathan D. Hiller, Irvine, CA (US); Stephen Lambert, Maryland Heights, MO (US); Todd Harding Tomkinson, Newbury Park, CA (US); Steven Fulton Griffin, Kihei, HI (US)

(21) Appl. No.: 18/442,953

(22) Filed: Feb. 15, 2024

(51) Int. Cl. G01S 17/42; G01S 7/499; G01S 17/95

(52) U.S. Cl. CPC G01S 17/42; G01S 7/499; G01S 17/95

(57) ABSTRACT

A laser beam scanning system comprises a lidar system in an aircraft and a controller. The lidar system is configured to emit a laser beam into an atmosphere during flight of the aircraft; receive backscatter light generated in response to emitting the laser beam; and generate backscatter data using the backscatter light. The controller is configured to control the lidar system to move the laser beam to scan an area using a pattern that is based on a sequence of locations in the pattern being nearest to a center of the area. The controller is configured to control the lidar system to generate measurements of the area using the backscatter data generated from scanning the area.

### CROSS-REFERENCE TO RELATED APPLICATIONS

This application is related to U.S. Patent Application entitled “Laser Scanning For Spatial Acquisition Of A Satellite Receiver,” Serial No.______; attorney docket no. 23-1025-US-NP, and U.S. Patent Application entitled “Laser Beam Based Flight Path Clearing System,” Serial No.______, attorney docket no. 23-1025-US-NP [3], both of which are filed even date hereof, assigned to the same assignee, and incorporated herein by reference in their entirety.

### BACKGROUND INFORMATION

### 1. Field

The present disclosure relates generally to aircraft and in particular, to making measurements using a laser sensor system.

### 2. Background

Laser-based sensor systems can replace many vital aircraft instruments and add new capabilities for aircraft. For example, a light detection and ranging (lidar) sensor can be used to measure various parameters during the flight of an aircraft. With a lidar sensor, a laser beam is emitted into the air. The laser beam encounters aerosols in the air that reflect or “backscatter” light towards the aircraft. Aerosols are fine solid particles, liquid particles, or both, suspended in air or other gases. The backscatter of the laser beam can also be caused by the molecules in the air or objects in the air.

The backscatter light generated in response to emitting the laser beam is detected. The backscatter light can be used to generate backscatter data that is analyzed to make measurements of one or more parameters. These parameters can include the speed of the aircraft, turbulence, air temperature, and other parameters.

### SUMMARY

An embodiment of the present disclosure provides a laser beam scanning system comprising a lidar system in an aircraft and a controller. The lidar system is configured to emit a laser beam into an atmosphere during flight of the aircraft; receive backscatter light generated in response to emitting the laser beam; and generate backscatter data using the backscatter light. The controller is configured to control the lidar system to move the laser beam to scan an area using a pattern that is based on a sequence of locations in the pattern being nearest to a center of the area. The controller is configured to control the lidar system to generate measurements of the area using the backscatter data generated from scanning the area.

Another embodiment of the present disclosure provides a method for making measurements with a laser beam. A laser beam being emitted into an atmosphere during the flight of an aircraft is moved to scan an area using a pattern that is based on a sequence of locations in the pattern being nearest to a center of the area. Backscatter light generated in response to the laser beam being emitted and moved to scan the area is detected. Measurements of the area generated using the backscatter data are generated from scanning the area.

Another embodiment of the present disclosure provides a laser beam scanning system comprising a lidar system in an aircraft and a controller. The lidar system is configured to emit a laser beam into an atmosphere during flight of the aircraft; receive backscatter light generated in response to emitting the laser beam; and generate backscatter data using the backscatter light. The controller is configured to control the lidar system to move the laser beam to scan an area using a pattern that is based on a sequence of locations in the pattern that are selected based on a scan metric.

### BRIEF DESCRIPTION OF THE DRAWINGS

The novel features believed characteristic of the illustrative examples are set forth in the appended claims. The illustrative examples, however, as well as a preferred mode of use, further objectives and features thereof, will best be understood by reference to the following detailed description of an illustrative example of the present disclosure when read in conjunction with the accompanying drawings, wherein:

FIG. 1 is an illustration of an aircraft in a turbulent environment in accordance with an illustrative example;

FIG. 2 is an illustration of a block diagram of a measurement environment in accordance with an illustrative example;

FIG. 3 is an illustration of a sequence of locations in a pattern in accordance with an illustrative example;

FIG. 4 is an illustration of locations for beam spots and angles between beam spots in accordance with an illustrative example;

FIG. 5 is an illustration of a flowchart of a process for identifying locations for scanning an area in accordance with an illustrative example;

FIG. 6 is an illustration of a flowchart of a process for making measurements for scanning an area in accordance with an illustrative example;

FIG. 7 is an illustration of a flowchart of a process for making measurements for volume in importance with an illustrative example;

FIG. 8 is an illustration of a flowchart of a process for moving a laser beam in accordance with an illustrative example;

FIG. 9 is an illustration of a flowchart of a process for moving a laser beam in accordance with an illustrative example; and

FIG. 10 is an illustration of a block diagram of a data processing system in accordance with an illustrative example.

### DETAILED DESCRIPTION

The illustrative examples recognize and take into account one or more different considerations as described herein. For example, directing a laser beam from a lidar system to obtain backscatter data for making measurements in different locations can be performed as quickly as possible. The faster at which measurements for detecting turbulence or windshear ahead of the aircraft are provided, more time is present to make changes in flight or make preparations for encountering turbulence or windshear.

In the illustrative example, a lidar system can be controlled to move a laser beam to different locations in an area ahead of the aircraft. Measurements may be made at these different locations. Measurements in these different locations can provide a picture of the environment ahead of the aircraft. For example, these measurements can provide an ability to visualize turbulence that may be ahead of the aircraft within the area ahead of the aircraft.

In the illustrative examples, the laser beam can be moved from one location in an area to another location to perform a scan of the area. This can provide measurements for the different locations in the area. These measurements can be, for example, turbulence, windshear, temperature, pressure, objects, and other types of measurements.

Increasing the speed at which the scan can be performed can increase the ability to make measurements to detect objects that may be located in one or more locations in the area being scanned. For example, measurements may identify a location of objects such as a flock of birds, insects, or other objects. Being able to identify these objects quickly can provide the pilot with more time to take action.

Thus, the illustrative examples provide a method, apparatus, system, and computer program product for making measurements with the laser beam. In one illustrative example, a laser beam being emitted in an atmosphere during the flight of an aircraft is moved to scan an area using a pattern that is based on a sequence of locations in the pattern being nearest to a center of the area. Backscatter light generated in response to the laser beam being emitted and moved to scan the area is detected. Measurements of the area are generated using the backscatter data generated from scanning the area.

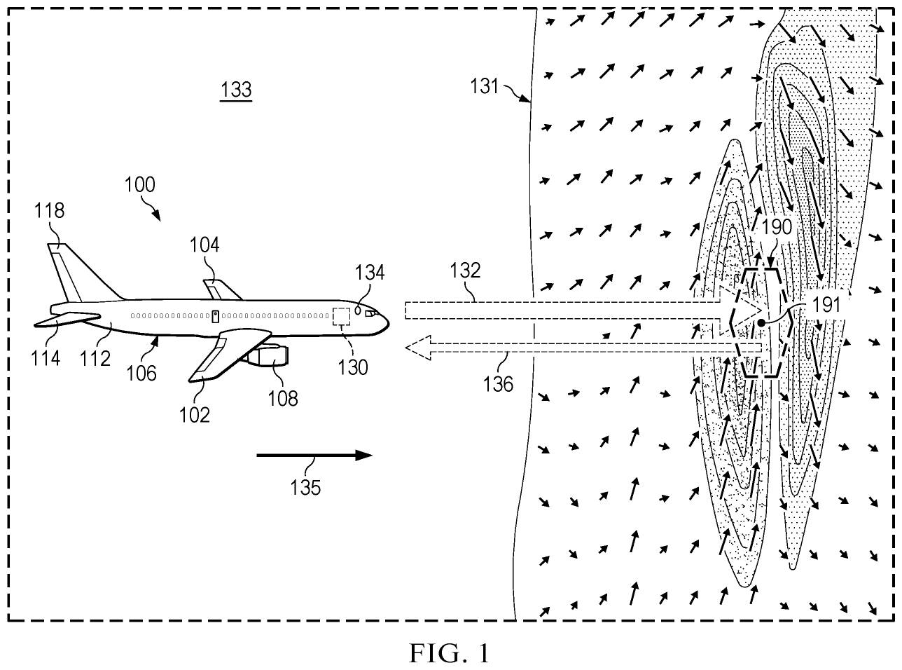

With reference now to the figures and, in particular, with reference to FIG. 1, an illustration of an aircraft in a turbulent environment is depicted in accordance with an illustrative example. In this illustrative example, commercial airplane 100 has wing 102 and wing 104 attached to body 106. In some examples, body 106 can also be referred to as the fuselage. Engine 108 is attached to wing 102. In this view of commercial airplane 100, another engine is attached to wing 104 but not seen in this view.

Body 106 has tail section 112. Horizontal stabilizer 114 and vertical stabilizer 118 are attached to tail section 112 of body 106. Another horizontal stabilizer is present but not shown in this view.

Commercial airplane 100 is an example of an air vehicle in which laser beam scanning system 130 can be implemented in accordance with an illustrative example. In this illustrative example, laser beam scanning system 130 scans the environment around commercial airplane 100 to make measurements of the environment around commercial airplane 100. For example, these measurements may include measurements that detect the presence of clear air turbulence 131, which cannot be seen by the pilot of commercial airplane 100.

Further, with these measurements, the pilot or an aircraft management system can operate commercial airplane 100 to at least one of reduce the effects of clear air turbulence 131 or increase the engine performance of commercial airplane 100 to increase fuel efficiency.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In this illustrative example, laser beam scanning system 130 can comprise a lidar system that operates to emit laser beam 132 from port 134 of commercial airplane 100. Laser beam 132 can have different wavelengths. For example, laser beam 132 can use an infrared wavelength of about 1550 nm or typically use an ultraviolet wavelength of about 350 nm.

As depicted, laser beam 132 is emitted in forward direction 135 relative to commercial airplane 100. This forward direction is relative to the direction of travel of commercial airplane 100 during flight.

In this depicted example, laser beam scanning system 130 receives backscatter light 136 generated in response to emitting laser beam 132. In this example, laser beam 132 is emitted into atmosphere 133 into clear air turbulence 131. Backscatter light 136 is received in response to emitting laser beam 132 and is used in this example to make measurements to detect the presence of clear air turbulence 131 ahead of commercial airplane 100.

In this illustrative example, laser beam 132 can be operated to scan area 190 ahead of commercial airplane 100. In this example, area 190 has the shape of a hexagon. The dimensions of area 190 can be based on the wingspan of commercial airplane 100. For example, if the wingspan is 60 meters, the diameter of area 190 can be 60 meters.

By scanning area 190, measurements can be made to determine the intensity of clear air turbulence 131 ahead commercial airplane 100. In this illustrative example, the scanning of area 190 can be performed by using a pattern based on sequence locations in the pattern being nearest to center 191 of area 190. In this example, the pattern begins around center 191 and moves outward. The sequence of locations does not need to be the nearest neighbor. At least some locations in the sequence are discontinuous from each other in this example.

Thus, laser beam scanning system 130 can operate to provide real time measurements of atmosphere 133 in area 190. These measurements can be used to adjust the flight of commercial airplane 100 to reduce the effects of clear air turbulence 131 in atmosphere 133 as compared to current techniques. Current techniques can forecast predictions of weather conditions that may result in clear air turbulence. However, these techniques do not enable pilot of commercial airplane 100 to make adjustments to reduce the effects of turbulence that may be directly ahead of the path of the commercial airplane 100.

In another illustrative example, laser beam scanning system 130 can also use the backscatter data to measure a number of environmental parameters that affect the performance of the engine for commercial airplane 100. As used herein, a “number of” when used with reference to items means one or more items. For example, a number of environmental parameters is one or more environmental parameters. The measurement of these parameters can be used by the pilots or a flight management system to manage commercial airplane 100 to make the adjustments that increase fuel efficiency.

This number of environmental parameters can include at least one of temperature, pressure, density, humidity, or other environmental parameters for the atmosphere that can affect the performance of engines for commercial airplane 100. With these measurements, the pilot or a flight management system can determine a change or adjustment to one or more flight control settings for commercial airplane 100. The settings can be selected to increase the engine performance of the engines for commercial airplane 100. Engine performance can be increased to reduce fuel usage for commercial airplane 100.

The generation of these measurements from the backscatter data can be made much faster as compared to a pilot or other person performing an analysis to make the predictions such as those made by laser beam scanning system 130. A human operator cannot practically perform these operations in real time to manage the flight of commercial airplane 100 to obtain desired performance of commercial airplane 100.

FIG. 1 is intended as an example and not as an architectural limitation for the different illustrative examples. For example, laser beam 132 can be embedded from other locations other than port 134 in body 106. In another illustrative example, laser beam 132 can be emitted from a port located in wing 104, horizontal stabilizer 114, vertical stabilizer 118, or other suitable locations.

In another illustrative example, laser beam 132 may encounter one or more objects in area 190 during scanning of area 190. In this example, backscatter light 136 can be used to generate backscatter data for measurements that determine the presence of these objects. These objects can be, for example, a flock of birds, insects, or other objects. In other illustrative examples, these objects can also be ice or hail.

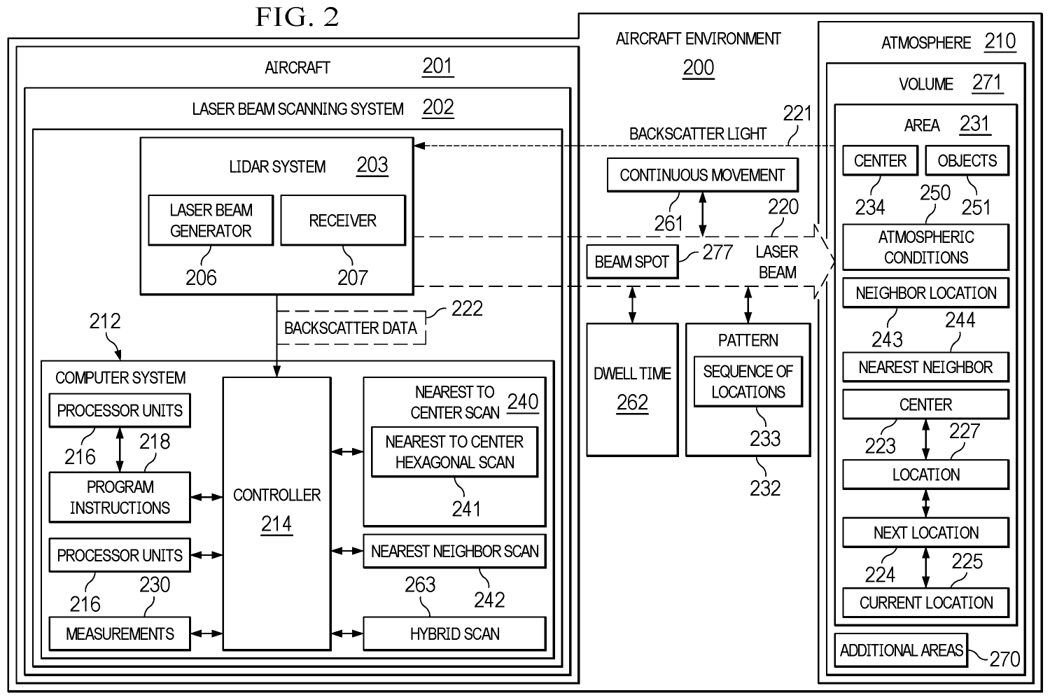

With reference now to FIG. 2, an illustration of a block diagram of a measurement environment is depicted in accordance with an illustrative example. In this illustrative example, aircraft environment 200 includes components that can be implemented in hardware in an aircraft such as commercial airplane 100 in FIG. 1.

In this illustrative example, laser beam scanning system 202 operates to generate measurements of atmosphere 210. In this example, laser beam scanning system 202 is located in aircraft 201.

Aircraft 201 can take a number of different forms. For example, aircraft 201 can be selected from a group comprising a commercial aircraft, a cargo airplane, a rotorcraft, a fixed wing aircraft, a tilt-rotor aircraft, a tilt wing aircraft, a vertical takeoff and landing aircraft, an electrical vertical takeoff and landing vehicle, a glider, a personal air vehicle and other types of aircraft that can fly in atmosphere 210.

As depicted, laser beam scanning system 202 comprises lidar system 203, computer system 212, and controller 214. Controller 214 is located in computer system 212. These components are located within aircraft 201 in this illustrative example. In this example, lidar system 203 is also referred to as a light detection and ranging (lidar) system.

Lidar system 203 is a hardware system and can include software. In this example, lidar system 203 includes laser beam generator 206 and receiver 207. Lidar system 203 can take a number of different forms. For example, lidar system 203 can be selected from a group comprising a coherent lidar system, a direct detection lidar system, a rotational Raman lidar system, and other suitable types of lidar systems.

Lidar system 203 emits laser beam 220 into atmosphere 210 during flight of aircraft 201. In this illustrative example, laser beam 220 is emitted in a direction that is at least one of ahead of aircraft 201 or to a side of aircraft 201 using laser beam generator 206. In other illustrative examples, laser beam 220 can be emitted in other directions from laser beam generator 206. Laser beam generator 206 is a hardware component that is configured to emit laser beam 220 into atmosphere 210.

In this example, the direction ahead of aircraft 201 is a direction in which aircraft 201 is traveling. Laser beam generator 206 controls characteristics of laser beam 220. These characteristics can include at least one of a wavelength, power, timing, and other characteristics. Further, laser beam 220 is selected from a group comprising a continuous laser beam and a pulsed laser beam. Laser beam 220 can also be a type wherein the laser beam is selected from a group comprising a CO2 laser beam, an infrared laser beam, a visible light laser beam, and other suitable types of laser beams. Further, laser beam 220 can be linearly polarized.

As depicted, one characteristic of laser beam 220 is beam spot 277. In this example, beam spot 277 is a diameter of laser beam 220 at a location in area 231. In this example, beam spots can correspond to locations in area 231. For example, location 227 in area 231 can have a size and shape that corresponds to beam spot 277 when laser beam 220 is directed at location 227.

In this example, lidar system 203 is configured to receive backscatter light 221 generated in response to emitting laser beam 220. In this example, backscatter light 221 is received by receiver 207 in lidar system 203. Receiver 207 is also a hardware component and includes sensors and at least one of electronics or computers.

Lidar system 203 generates backscatter data 222 using backscatter light 221. This generation of backscatter data 222 is formed by receiver 207 in lidar system 203. Backscatter data 222 is sent to controller 214 for processing. Controller 214 processes backscatter data 222 to generate measurements 230.

Controller 214 can be implemented in software, hardware, firmware, or a combination thereof. When software is used, the operations performed by controller 214 can be implemented in program instructions configured to run on hardware, such as a processor unit. When firmware is used, the operations performed by controller 214 can be implemented in program instructions and data can be stored in persistent memory to run on a processor unit. When hardware is employed, the hardware can include circuits that operate to perform the operations in controller 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operates a computer. When the number of processor units 216 executes program instructions 218 for a process, the number of processor units 216 can be one or more processor units that are in the same computer or in different computers. In other words, the process can be distributed between number of processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, controller 214 controls lidar system 203 to move laser beam 220 to scan area 231 using pattern 232 that is based on sequence of locations 233 in pattern 232 being nearest to center 234 of area 231. Pattern 232 can have a number of different shapes. For example, pattern 232 can have a shape selected from a group comprising a hexagon, a pentagon, an octagon, and other suitable shapes. In this illustrative example, the shapes do not need to be symmetrical.

In this illustrative example, in moving of laser beam 220, laser beam 220 can have at least one of continuous movement 261 or can have dwell time 262 at each location in sequence of locations 233.

In this example, laser beam 220 is moved from location to location in sequence of locations 233 in pattern 232. For example, location 227 nearest to center 223 of area 231 can be determined using a probability density function (PDF) that shows what location is likely to be closest to center 223. The probability density function can be, for example, a Gaussian function, an analytical distribution, a skewed distribution, or other type of probability density function. In this example, center 223 is the peak of the probability density function when the probability density function has a single peak.

In this example, the probability density function relates to or represents physical measurements. For example, the probability density function can represent the “level of importance” that a measurement at a particular point in space is to the aircraft. A measurement of air turbulence, temperature, or density is most important for a point in space that is directly in the flightpath of the aircraft. A measurement of air turbulence, temperature, or density is much less important for a point in space that is hundreds of meters off the flightpath. Thus, in this illustrative example, the probability density function is a curve that peaks at a point on the flight path, and decreases as the measurement point moves away from the flightpath. Measurements away from the flight path are measured on an axis that is orthogonal or perpendicular to the flightpath axis.

In this example, the “level of importance” is the probability that an atmospheric condition at some point in space (air turbulence, temperature, density) will affect the aircraft. These aircraft effects include, aircraft engine fuel efficiency, aircraft aerodynamics, and aircraft accelerations caused by air turbulence.

Controller 214 controls lidar system 203 to move laser beam 220 from location 227 to next location 224 nearest to center 223 of area 281. In this example, next location 224 becomes current location 225 for laser beam 220. This movement of laser bream 220 continues until area 231 has been scanned. The movement from the current location to the next location is such that laser beam 220 follows sequence of locations 233 for pattern 232.

This movement of laser beam 220 can be performed using nearest neighbor scan 242. This type of scan can be faster than moving laser beam 220 between adjacent locations.

For example, controller 214 can move laser beam 220 from current location 225 to next location 224 nearest to center 223 in area 231 from current location 225. This type of scan is nearest to center scan 240. When area 231 has the shape of a hexagon, the scan can be referred to as nearest to center hexagonal scan 241.

Further, controller 214 can control the movement of laser beam 220 to change from nearest to center scan 240 to nearest neighbor scan 242. This type of scan in which the scanning changes from nearest to center scan 240 to nearest neighbor scan 242 is referred to as hybrid scan 263. This change can be made when moving from one location to another location that is adjacent to each other using nearest neighbor scan 242 is faster than moving to a nonadjacent location using nearest to center scan 240.

For example, controller 214 moves laser beam 220 to neighbor location 243 of nearest neighbor 244 in response to the time for moving laser beam 220 from current location 225 to next location 224 using location 227 nearest to center 223 of area 231 being greater than a threshold. These locations are adjacent to each other when using nearest neighbor scan 242.

Controller 214 also generates measurements 230 of area 231 using the backscatter data 222 generated from scanning area 231 by lidar system 203. In this example, measurements 230 are for at least one of atmospheric conditions 250 or objects 251 that may be in area 231. Atmospheric conditions 250 can take a number of different forms. For example, atmospheric conditions 250 can be selected from at least one of air density, temperature, speed of air, turbulence, or other conditions. Objects 251 can be selected from at least one of insects, birds, bats, water droplets, or other objects that may be within area 231 in atmosphere 210.

In one illustrative example, controller 214 moves laser beam 220 to scan a number of additional areas 270 at different distances from aircraft 201. In this example, controller 214 generates measurements 230 for volume 271 formed by area 231 in the number of additional areas 270.

In one illustrative example, one or more solutions are present that overcome a problem with measurements as quickly as possible. Increasing speed at which measurements can be made provides a pilot or a control system more time to make changes to the operation of an aircraft. These changes can be made to avoid or reduce the effects of environmental conditions such as turbulence or windshear. Additionally, changes can be made based on measurements such as temperature and pressure to increase the fuel efficiency of an aircraft.

In this illustrative example, a pattern with a sequence of locations based on being nearest to center of an area is used to scan the area. This sequence of locations in the pattern can enable scanning the area faster as compared to current techniques that scan on a nearest neighbor basis in which the laser beam is moved from one location to another location in which these locations are adjacent to each other.

In this example, controller 214 transforms computer system 212 into a special purpose computer system as compared to currently available general computer systems that do not have controller 214. In the illustrative example, the use of controller 214 in computer system 212 integrates processes into a practical application for the laser beam to scan an area using a pattern based on sequence of locations in the pattern being nearest to a center of the area. Measurements can be generated based on the backscatter data created from backscatter light detected in response to laser beam 220.

In these examples, controller 214 in computer system 212 is directed to a practical application of processes integrated into controller 214 in computer system 212 that enables making measurements more quickly such that these measurements can be used to manage the operation of aircraft 201.

The illustration of aircraft environment 200 in FIG. 2 is not meant to imply physical or architectural limitations to the manner in which an illustrative example may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative example.

In another example, a controller, such as controller 214, controls lidar system 203 to move a laser beam to scan area 400 using a pattern that comprises a sequence of locations in the pattern that are selected based on a scan metric. The controller 214 moves the laser beam from the location to a next location in a sequence of locations 233 using the scan metric. The next location becomes the current location for the laser beam. The movement of the laser beam from the current location to the next location continues until area 231 has been scanned.

The controller selects the next location in area 400 from a set of candidate locations that has a highest value for the scan metric. The scan metric is as follows:

$$M = {PDF}_{int} / {t}_{tot}$$

where PDFᵢₙₜ is a probability density function integrated over an area of interest for a next potential location and tₜₒₜ is a total time, tₜₒₜ=t_{slew}+t_{dwell}, t_{slew} is a time to slew a line-of-sight from the current location to the next potential location, and t_{dwell} is a time the line-of-sight dwells at the next potential location. This process can be repeated to select the sequence of locations for the pattern.

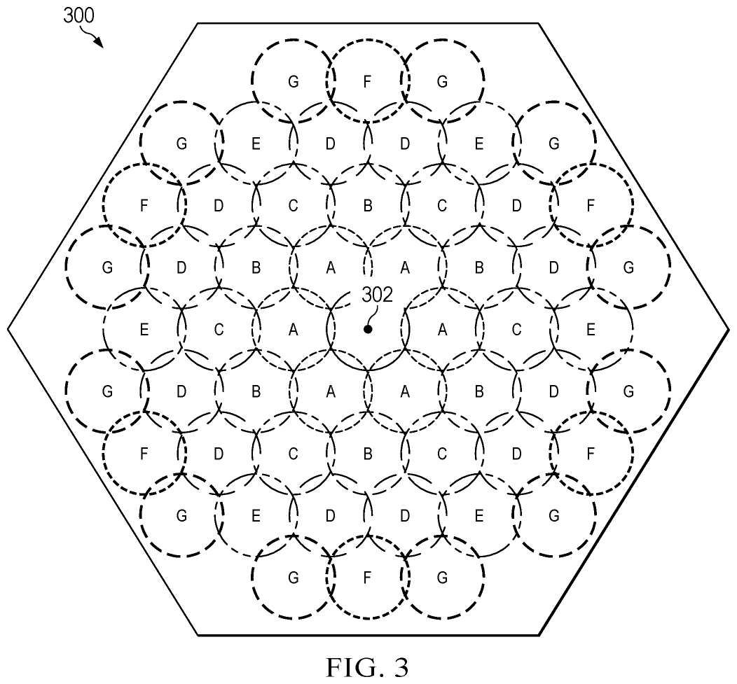

With reference now to FIG. 3, an illustration of a sequence of locations in a pattern is depicted in accordance with an illustrative example. In this example, sequence locations 304 for a pattern are depicted within area 300. This area is an example of area 190 in FIG. 1, area 231 in FIG. 2, and additional areas 270 in FIG. 2. As depicted, area 300 has a hexagonal shape. Sequence of locations 404 is an example of sequence of locations 233 in FIG. 2.

In this example, locations can be selected to be the nearest to center 302 of area 300. For example, the first location can be the location for center 302. The next locations closest to center 302 are locations A.

Locations selected that are closest to center 302 after locations A are locations B. The next locations used for pointing laser beams are locations C. The next locations closest to center 302 are locations D with locations E being the next locations closest to the center after locations D. The next locations closest to center 302 are locations F followed by locations G.

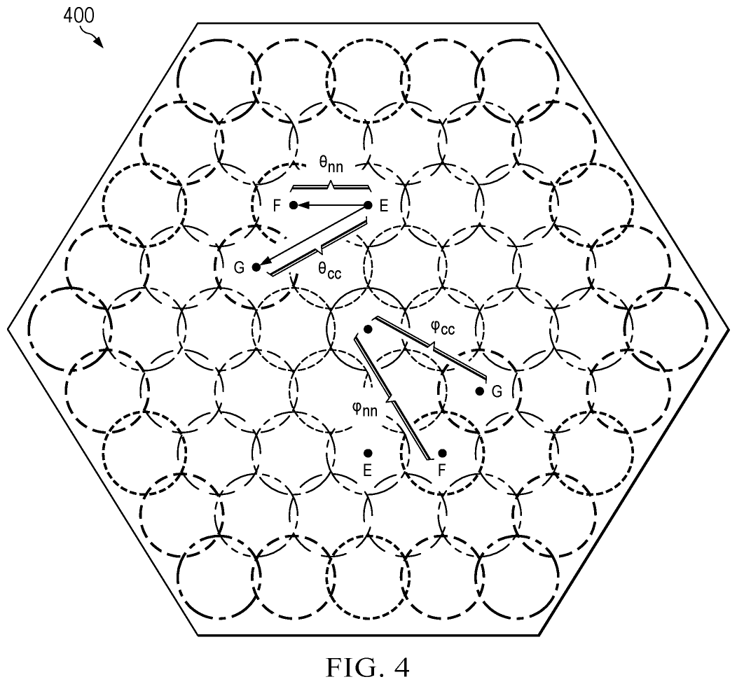

Turning to FIG. 4, an illustration of locations for beam spots and angles between beam spots is depicted in accordance with an illustrative example. In this example, a scan for directing a laser beam at beam spots in a pattern in area 400 can be performed using a nearest to center scan. The pattern includes the location of beam spots as well as an order in which a laser beam is directed to the different beam spots. This order can be sequence of locations 233 in FIG. 2 for pattern 232. This pattern can also be referred to as a beam spot pattern.

As depicted, angle ⊖cc is between beam spot E and beam spot G, and angle ⊖nn is between beam spot E and beam spot F. Also shown is angle (cc between the center and beam spot G and angle ⊖nn is between the center and beam spot F. These angles can be used in determining a pattern of beam spots for pointing a laser beam.

In this example, the beam spot pattern can be determined using a nearest to center scan. For a given beam spot pattern, the following equation can be used:

$${t}_{net savings} \approx \frac{{t}_{s c a n}}{N} [ PDF ( {φ}_{c c} ) - PDF ( {φ}_{n n} ) ] - \frac{{θ}_{c c} - {θ}_{n n}}{slew rate} \qquad Equation A$$

where t_{net_savings} is the time saved for a single jump from beam spot to beam spot using the nearest to center scan relative to the nearest neighbor scan. In other words, this variable is the time it takes for a single jump from one beam spot to another beam spot using the nearest to center scan approach minus the time it takes for a single jump from beam spot to beam spot using the nearest neighbor scan to determine the beam spot pattern.

t_{scan} is the total scan time to use the nearest neighbor scan.

N is the total number of beam spots in the scan pattern.

PDF(φ_{cc}) is a unitless value of the probability density function for the beam spot that was moved to the nearest to center scan. This value is a function of distance from the beam spot to the center of the probability density function, which is equivalent to an angle defined as “φ”.

PDF(φₙₙ) is the unitless value of the probability density function for the beam spot that was moved to the nearest neighbor scan.

θ_{cc} is the angular separation between two beam spots when jumping from beam spot to beam spot using the nearest to center scan. The units can be degrees or radians.

θₙₙ is the angular separation between two beam spots when jumping from beam spot to beam spot using the nearest neighbor scan.

slew rate is the speed at which the gimble moves. The units are angular change over time (e.g., degree/s or rad/s).

### Example 1

In this example, the slew rate is infinite. This infinite slew rate means the laser beam instantly jumps from beam spot to beam spot. In this case, Equation A becomes:

$${t}_{net savings} \approx \frac{{t}_{s c a n}}{N} [ PDF ( {φ}_{c c} ) - PDF ( {φ}_{n n} ) ] - \frac{{θ}_{c c} - {θ}_{n n}}{∞} = \frac{{t}_{scan}}{N} [ PDF ( {φ}_{cc} ) - PDF ( {φ}_{nn} ) ]$$

Since PDF(φ_{cc})cc)≥PDF(φₙₙ), t_{net_savings}≥0, there is never a need to switch from the closest to center scan to the nearest neighbor scan for determining the beam spot pattern.

### Example 2

In this example, the slew rate can be considered zero resulting in the following:

$${t}_{net savings} \approx \frac{{t}_{s c a n}}{N} [ PDF ( {φ}_{c c} ) - PDF ( {φ}_{n n} ) ] - \frac{{θ}_{c c} - {θ}_{n n}}{0} = - ∞$$

In this case, the nearest to center scan is not needed because the t_{net_savings}<0.

### Example 3

Example 1 showed that if the slew rate is sufficiently fast, it always saves time to use the nearest to center scan to determine a beam spot pattern. Example 2 shows that if the slew rate is sufficiently slow, no time savings is present. In this example, the nearest neighbor scan is used.

If the slew rate is something in between these extremes, initially, time savings are present using the nearest to center scan.

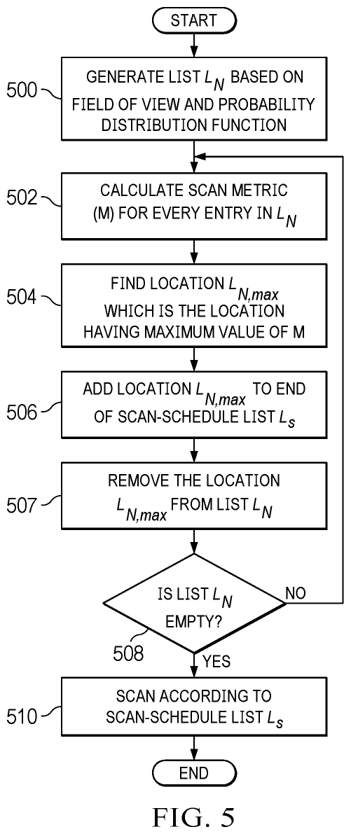

With reference next to FIG. 5, an illustration of a flowchart of a process for identifying locations for scanning an area in accordance with an illustrative example is depicted. The process in FIG. 5 can be implemented in hardware, software, or both. When implemented in software, the process can take the form of program instructions that are run by one or more processor units located in one or more hardware devices in one or more computer systems. This process can be implemented to identify locations in a sequence of locations in a pattern for scanning an area. For example, the process can be implemented in controller 214 in computer system 212 in FIG. 2.

The process begins by generating a list L_{N} of all possible locations for the next scan step (operation 500). In operation 500, the possible locations are potential next locations for scanning. The process calculates a scan metric (M) for every entry in the list (L_{N}) (operation 502).

In operation 502, the scan metric is as follows:

$$M = {PFD}_{i n t} / {t}_{tot}$$

where PDFᵢₙₜ is the probability density function (PDF) integrated over an area of interest (AOI) for the next potential dwell location. The PDF shows what location is likely to be closest to center or maximum of an area being scanned. The probability density function can be, for example, a Gaussian function, analytical distribution, a skewed distribution, or other type of probability density function. In this example, center 223 is the peak of the probability density function when the probability density function has a single peak. In another example, the maximum probability density function can be used when the maximum is not the center of the probability density function.

The area of interest for pointing a laser beam is the region over which the laser beam exceeds the detection threshold. For example, the area of interest is for a region over which the laser beam has characteristics at a level (threshold) that generates backscatter light that can be detected by the lidar system. In other words, the laser beam has characteristics that generate backscatter light that can be detected by the lidar system within the area of interest.

In this example, the total time, tₜₒₜ, is given by tₜₒₜ=t_{slew}+t_{dwell}, where t_{slew} is the time it takes to slew the line-of-sight (LOS) from the current dwell location to the next potential location, and t_{dwell} is the time the line-of-sight dwells at the next potential location. After the dwell at the current location, that dwell location is removed from the list of next possible dwell locations, and the process is repeated until there are no remaining possible dwell locations. The line-of-sight can be the center of the field of view and is moved to point the laser beam at different locations.

The process finds location ^{L}_{N,max}, Which is the location having maximum value of M (operation 504). In operation 504, the location L_{N,max} is the location in the list L_{N} with the maximum value for M. The system adds the location ^{L}_{N,max} to the end of scan-schedule list Lₛ (operation 506). In operation 506, the scan-schedule list Lₛ is a scan-schedule list that saves an optimal order of scan steps to use in moving the laser beam to different locations.

The process then removes the location ^{L}_{N,max}, from list L_{N} (operation 507). The process determines whether the list L_{N} is empty (operation 508). In operation 508, if list L_{N} is not empty, the process returns to operation 502. Otherwise, the process proceeds to scan according to the scan-schedule list Lₛ (operation 510) with the process terminating thereafter. Thus, this process generates a sequence of locations for a pattern to scan the area.

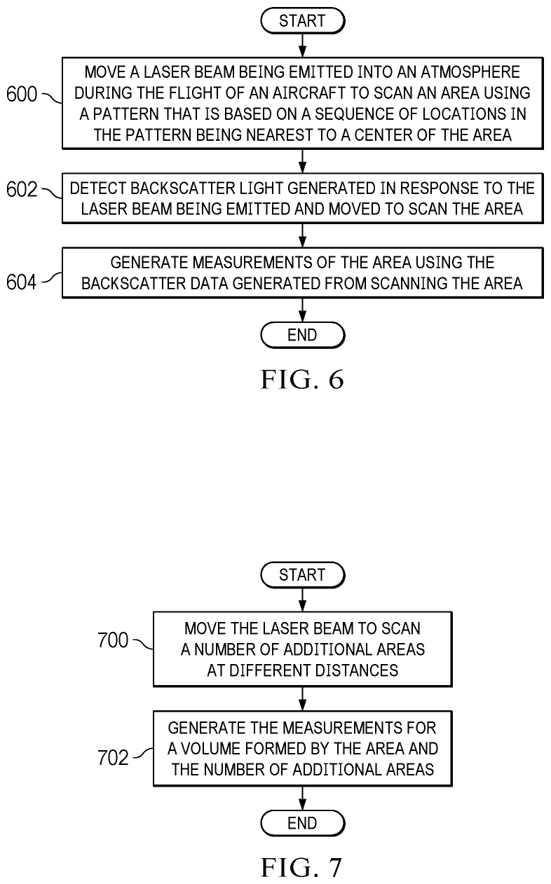

With reference to FIG. 6, an illustration of a flowchart of a process for making measurements for scanning an area in accordance with an illustrative example is depicted. The process in FIG. 6 can be implemented in hardware, software, or both. When implemented in software, the process can take the form of program instructions that are run by one or more processor units located in one or more hardware devices in one or more computer systems. This process can be implemented to identify locations for pointing a laser beam emitted from a laser beam system. For example, the process can be implemented in controller 214 in computer system 212 in FIG. 2.

The process moves a laser beam being emitted into an atmosphere during the flight of an aircraft to scan an area using a pattern that is based on a sequence of locations in the pattern being nearest to a center of the area (operation 600). The process detects backscatter light generated in response to the laser beam being emitted and moved to scan the area (operation 602).

The process generates measurements of the area using the backscatter data generated from scanning the area (operation 604). The process terminates thereafter.

Next in FIG. 7, an illustration of a flowchart of a process for making measurements for volume is depicted in accordance with an illustrative example. The operations in this flowchart are examples of additional operations that can be performed with the operations in FIG. 6.

The process moves the laser beam to scan a number of additional areas at different distances (operation 700). The process generates the measurements for a volume formed by the area and the number of additional areas (operation 702). The process terminates thereafter.

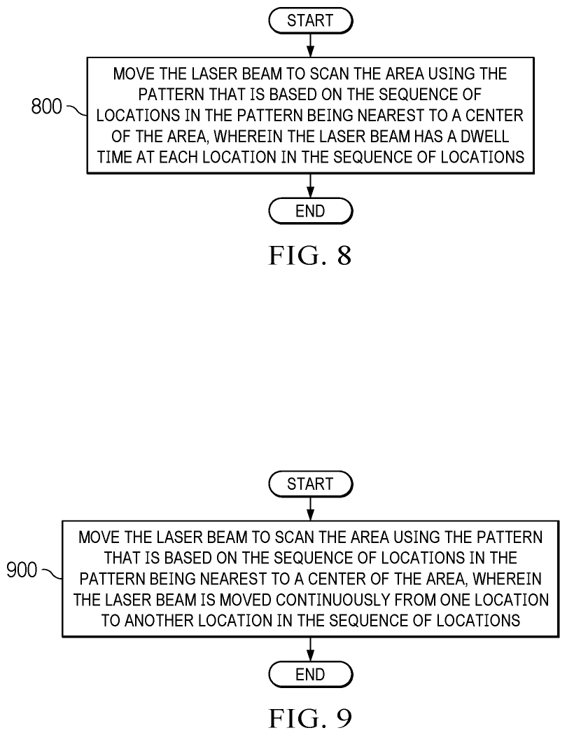

With reference next to FIG. 8, an illustration of a flowchart of a process for moving a laser beam is depicted in accordance with an illustrative example. The process in this figure is an example of an implementation for operation 600 in FIG. 6.

The process moves the laser beam to scan the area using the pattern that is based on the sequence of locations in the pattern being nearest to a center of the area, wherein the laser beam has a dwell time at each location in the sequence of locations (operation 800). The process terminates thereafter.

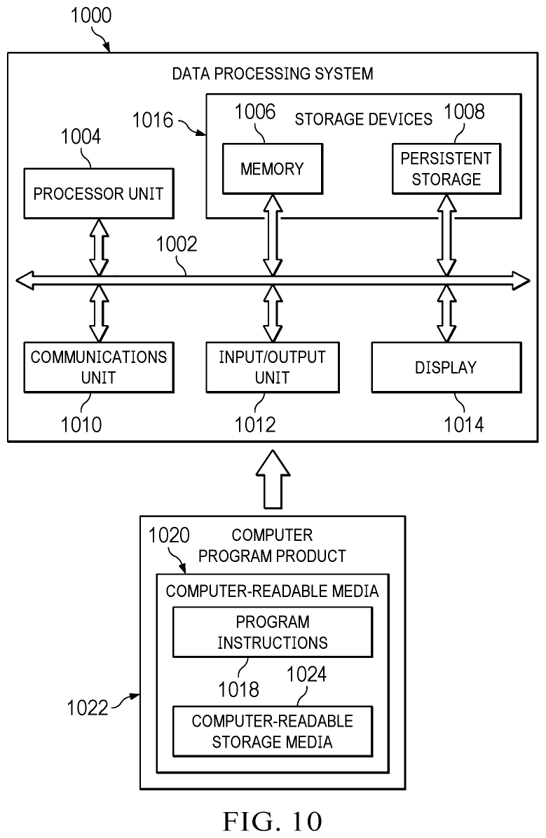

With reference next to FIG. 9, an illustration of a flowchart of a process for moving a laser beam is depicted in accordance with an illustrative example. The process in this figure is an example of an implementation for operation 600 in FIG. 6.

The process moves the laser beam to scan the area using the pattern that is based on the sequence of locations in the pattern being nearest to a center of the area, wherein the laser beam is moved continuously from one location to another location in the sequence of locations (operation 900). The process terminates thereafter.

The flowcharts and block diagrams in the different depicted embodiments illustrate the architecture, functionality, and operation of some possible implementations of apparatuses and methods in an illustrative example. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative example, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The illustrative examples provide a method, apparatus, system, and computer program product for making measurements using a laser being. In one illustrative example, a laser beam scanning system comprises a lidar system in an aircraft and a controller. The lidar system is configured to emit a laser beam into an atmosphere during flight of the aircraft; receive backscatter light generated in response to emitting the laser beam; and generate backscatter data using the backscatter light. The controller is configured to control the lidar system to move the laser beam to scan an area using a pattern that is based on a sequence of locations in the pattern being nearest to a center of the area. The controller is configured to control the lidar system to generate measurements of the area using the backscatter data generated from scanning the area.

The sequence of locations may have locations that are not contiguous or next to each other. As a result, faster scanning of the area can occur compared to current techniques that move from one location to the next location that is a nearest neighbor.

Turning now to FIG. 10, an illustration of a block diagram of a data processing system is depicted in accordance with an illustrative example. Data processing system 1000 can be used to implement computer system 212 in FIG. 2. In this illustrative example, data processing system 1000 includes communications framework 1002, which provides communications between processor unit 1004, memory 1006, persistent storage 1008, communications unit 1010, input/output (I/O) unit 1012, and display 1014. In this example, communications framework 1002 takes the form of a bus system.

Processor unit 1004 serves to execute instructions for software that can be loaded into memory 1006. Processor unit 1004 includes one or more processors. For example, processor unit 1004 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1004 can be implemented using one or more heterogeneous processor systems in which a main processor is present with secondary processors on a single chip. As another illustrative example, processor unit 1004 can be a symmetric multi-processor system containing multiple processors of the same type on a single chip.

Memory 1006 and persistent storage 1008 are examples of storage devices 1016. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1016 may also be referred to as computer-readable storage devices in these illustrative examples. Memory 1006, in these examples, can be, for example, a random-access memory or any other suitable volatile or non-volatile storage device. Persistent storage 1008 may take various forms, depending on the particular implementation.

For example, persistent storage 1008 may contain one or more components or devices. For example, persistent storage 1008 can be a hard drive, a solid-state drive (SSD), a flash memory, a rewritable optical disk, a rewritable magnetic tape, or some combination of the above. The media used by persistent storage 1008 also can be removable. For example, a removable hard drive can be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that can be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs can be located in storage devices 1016, which are in communication with processor unit 1004 through communications framework 1002. The processes of the different embodiments can be performed by processor unit 1004 using computer-implemented instructions, which may be located in a memory, such as memory 1006.

These instructions are referred to as program instructions, computer usable program instructions, or computer-readable program instructions that can be read and executed by a processor in processor unit 1004. The program instructions in the different embodiments can be embodied on different physical or computer-readable storage media, such as memory 1006 or persistent storage 1008.

Program instructions 1018 are located in a functional form on computer-readable media 1020 that is selectively removable and can be loaded onto or transferred to data processing system 1000 for execution by processor unit 1004. Program instructions 1018 and computer-readable media 1020 form computer program product 1022 in these illustrative examples. In the illustrative example, computer-readable media 1020 is computer-readable storage media 1024.

Computer-readable storage media 1024 is a physical or tangible storage device used to store program instructions 1018 rather than a medium that propagates or transmits program instructions 1018. Computer-readable storage media 1024 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 1024, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1018 can be transferred to data processing system 1000 using a computer-readable signal media. The computer-readable signal media are signals and can be, for example, a propagated data signal containing program instructions 1018. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1020” can be singular or plural. For example, program instructions 1018 can be located in computer-readable media 1020 in the form of a single storage device or system. In another example, program instructions 1018 can be located in computer-readable media 1020 that is distributed in multiple data processing systems. In other words, some instructions in program instructions 1018 can be located in one data processing system while other instructions in program instructions 1018 can be located in one data processing system. For example, a portion of program instructions 1018 can be located in computer-readable media 1020 in a server computer while another portion of program instructions 1018 can be located in computer-readable media 1020 located in a set of client computers.

The different components illustrated for data processing system 1000 are not meant to provide architectural limitations to the manner in which different embodiments can be implemented. In some illustrative examples, one or more of the components may be incorporated in or otherwise form a portion of, another component. For example, memory 1006, or portions thereof, may be incorporated in processor unit 1004 in some illustrative examples. The different illustrative examples can be implemented in a data processing system including components in addition to or in place of those illustrated for data processing system 1000. Other components shown in FIG. 10 can be varied from the illustrative examples shown. The different embodiments can be implemented using any hardware device or system capable of running program instructions 1018.

The description of the different illustrative examples has been presented for purposes of illustration and description and is not intended to be exhaustive or limited to the embodiments in the form disclosed. The different illustrative examples describe components that perform actions or operations. In an illustrative example, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative examples may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A laser beam scanning system comprising:
a lidar system in an aircraft, wherein the lidar system is configured to:
emit a laser beam into an atmosphere during flight of the aircraft;
receive backscatter light generated in response to emitting the laser beam; and
generate backscatter data using the backscatter light; and
a controller configured to:
control the lidar system to move the laser beam to scan an area using a pattern that is based on a sequence of locations in the pattern being nearest to a center of the area; and
generate measurements of the area using the backscatter data generated from scanning the area.

2. The laser beam scanning system of claim 1, wherein the controller is configured to:
move the laser beam to scan a number of additional areas at different distances from the aircraft; and
generate the measurements for a volume formed by the area and the number of additional areas.

3. The laser beam scanning system of claim 1, wherein in moving the laser beam, the controller is configured to:
move the laser beam to scan the area using the pattern that is based on the sequence of locations in the pattern being nearest to the center of the area, wherein the laser beam has a dwell time at each location in the sequence of locations.

4. The laser beam scanning system of claim 1, wherein in moving the laser beam, the controller is configured to:
move the laser beam to scan the area using the pattern that is based on the sequence of locations in the pattern being nearest to the center of the area, wherein the laser beam is moved continuously from one location to another location in the sequence of locations.

5. The laser beam scanning system of claim 1, wherein the pattern has a shape selected from a group comprising a hexagon, a pentagon, and an octagon.

6. The laser beam scanning system of claim 1, wherein the laser beam is emitted in a direction that is at least one of ahead of the aircraft or to a side of the aircraft.

7. The laser beam scanning system of claim 1, wherein measurements are for at least one of an atmospheric conditions or objects.

8. The laser beam scanning system of claim 7, wherein the atmospheric conditions are selected from at least one of air density, temperature, speed of air, or turbulence.

9. The laser beam scanning system of claim 7, wherein the objects are selected from at least one of insects, birds, bats, or water droplets.

10. The laser beam scanning system of claim 1, wherein the laser beam is selected from a group comprising a continuous laser beam and a pulsed laser beam.

11. The laser beam scanning system of claim 1, wherein the laser beam is linearly polarized.

12. The laser beam scanning system of claim 1, wherein the aircraft is selected from a group comprising a commercial aircraft, a cargo airplane, a rotorcraft, a fixed wing aircraft, a tilt-rotor aircraft, a tilt wing aircraft, a vertical takeoff and landing aircraft, an electrical vertical takeoff and landing vehicle, a glider, and a personal air vehicle.

13. The laser beam scanning system of claim 1, wherein the lidar system is selected from a group comprising a coherent lidar system, a direct detection lidar system, and a rotational Raman lidar system.

14. The laser beam scanning system of claim 1, wherein the laser beam is selected from a group comprising a CO2 laser beam, an infrared laser beam, and a visible light laser beam.

15. A method for making measurements with a laser beam, the method comprising:
moving the laser beam being emitted into an atmosphere during a flight of an aircraft to scan an area using a pattern that is based on a sequence of locations in the pattern being nearest to a center of the area;
detecting backscatter light generated in response to the laser beam being emitted and moved to scan the area; and
generating measurements of the area using backscatter data generated from scanning the area.

16. The method of claim 15 further comprising:
moving the laser beam to scan a number of additional areas at different distances; and
generating the measurements for a volume formed by the area and the number of additional areas.

17. The method of claim 15, wherein moving the laser beam comprises:
moving the laser beam to scan the area using the pattern that is based on the sequence of locations in the pattern being nearest to the center of the area, wherein the laser beam has a dwell time at each location in the sequence of locations.

18. The method of claim 15, wherein moving the laser beam comprises:
moving the laser beam to scan the area using the pattern that is based on the sequence of locations in the pattern being nearest to the center of the area, wherein the laser beam is moved continuously from one location to another location in the sequence of locations.

19. The method of claim 15, wherein the pattern has a shape selected from a group comprising hexagon, a pentagon, and an octagon.

20. The method of claim 15, wherein the laser beam is emitted in a direction that is at least one of ahead of the aircraft or to a side of the aircraft.

21. The method of claim 15, wherein measurements are for at least one of an atmospheric conditions or objects.

22. The method of claim 21, wherein the atmospheric conditions are selected from at least one of air density, temperature, speed of air, or turbulence.

23. The method of claim 21, wherein the objects are selected from at least one of insects, birds, bats, or water droplets.

24. The method of claim 15, wherein the laser beam is one of a continuous laser beam and a pulsed laser beam.

25. The method of claim 15, wherein the laser beam is linearly polarized.

26. The method of claim 15, wherein the aircraft is selected from a group comprising a commercial aircraft, a rotorcraft, a fixed wing aircraft, a tilt-rotor aircraft, a tilt wing aircraft, a vertical takeoff and landing aircraft, an electrical vertical takeoff and landing vehicle, and a personal air vehicle.

27. The method of claim 15, wherein the laser beam is emitted from a lidar system selected from one of coherent lidar system, a direct detection lidar system, and a rotational Raman lidar system.

28. The method of claim 15, wherein the laser beam is selected from a group comprising a CO2 laser beam, an infrared laser beam, and a visible light laser beam.

29. A laser beam scanning system comprising:
a lidar system in an aircraft, wherein the lidar system is configured to:
emit a laser beam into an atmosphere during flight of the aircraft;
receive backscatter light generated in response to emitting the laser beam; and
generate backscatter data using the backscatter light; and
a controller configured to control the lidar system to:
move the laser beam to scan an area using a pattern that comprises a sequence of locations in the pattern that are selected based on a scan metric; and
generate measurements of the area using the backscatter data generated from scanning the area.

30. The laser beam scanning system of claim 29, wherein the controller selects the next location in the area from a set of candidate locations that has a highest value for the scan metric, wherein the scan metric is as follows:
M=PDFᵢₙₜ/tₜₒₜ
where PDFᵢₙₜ is a probability density function integrated over an area of interest for a next potential location and tₜₒₜ is a total time, tₜₒₜ=t_{slew}+t_{dwell}, t_{slew} is a time to slew a line-of-sight from a current location to the next potential location, and t_{dwell} is a time the line-of-sight dwells at the next potential location.
